(19) United States
(12) Patent Application Publication
(10) Pub. No.: US 2025/0243820 A1
(43) Pub. Date: Jul. 31, 2025

(54) HYDROGEN ENGINE CONTROLLER

(71) Applicant: TOYOTA JIDOSHA KABUSHIKI KAISHA, Toyota-shi (JP)

(72) Inventor: Masanori TOYA, Inazawa-shi (JP)

(21) Appl. No.: 18/976,340

(22) Filed: Dec. 11, 2024

(30) Foreign Application Priority Data
Jan. 29, 2024 (JP) 2024-010994

(51) Int. Cl. F02D 41/00; F02D 19/02

(52) U.S. Cl. CPC F02D 41/0027; F02D 19/024

(57) ABSTRACT

The hydrogen engine includes a forced induction device and a plurality of cylinders. A controller for a hydrogen engine repeatedly sets a target fuel injection amount based on a target engine torque. The controller repeatedly determines whether anomaly combustion, which is an anomaly in which combustion occurs at a timing different from the ignition timing, is occurring. The controller executes the intake system anomaly determination process on condition that it is determined that anomaly combustion has occurred in two or more of the plurality of cylinders. The intake system anomaly determination process is a process of determining whether an intake system anomaly, which is an anomaly in which the amount of air supplied to the plurality of cylinders decreases, has occurred. The controller limits the target fuel injection amount when determining that the intake system anomaly has occurred.

### CROSS-REFERENCE TO RELATED APPLICATIONS

This application is based upon and claims the benefit of priority from Japanese Patent Application No. 2024-010994, filed on Jan. 29, 2024, the entire contents of which are incorporated herein by reference.

### BACKGROUND

### 1. Field

The following description relates to a hydrogen engine controller.

### 2. Description of Related Art

Japanese Laid-Open Patent Publication No. 2006-250056 discloses a controller for a hydrogen engine. The controller sets a target fuel injection amount based on the target engine torque.

The target fuel injection amount is set so as to be proportional to the target engine torque. During operation of the hydrogen engine, sufficient air for lean combustion is normally supplied to cylinders of the hydrogen engine.

For example, in a hydrogen engine including a forced induction device, there is a possibility of occurrence of an anomaly in which the wastegate valve cannot be closed. In such a case, the turbine wheel of the forced induction device cannot be sufficiently rotated by exhaust gas. As a result, sufficient air cannot be fed into the cylinders. Similar incidents may also occur when an anomaly occurs in which exhaust gas leaks from the exhaust passage at a location upstream of the turbine wheel in the exhaust passage.

In such a case, the actual amount of air may be significantly smaller than the amount of air needed to perform lean combustion. As described above, when the air-fuel ratio becomes rich, anomaly combustion such as knocking and/or pre-ignition is more likely to occur. It is desirable to minimize occurrence of such anomaly combustion.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In an aspect of the present disclosure, a hydrogen engine controller is configured to control a hydrogen engine including a forced induction device and cylinders. The hydrogen engine controller includes processing circuitry. The processing circuitry is configured to repeatedly set a target fuel injection amount based on a target engine torque. The processing circuitry is configured to repeatedly determine whether an anomaly combustion is occurring. The anomaly combustion is an anomaly in which a combustion occurs at a point in time differing from an ignition timing. When determining that the anomaly combustion has occurred in two or more of the cylinders, the processing circuitry is configured to determine whether an intake system anomaly has occurred. The intake system anomaly is an anomaly in which an amount of air supplied to the cylinders is decreased. When determining that the intake system anomaly has occurred, the processing circuitry is configured to limit the target fuel injection amount.

Other features and aspects will be apparent from the following detailed description, the drawings, and the claims.

### BRIEF DESCRIPTION OF THE DRAWINGS

FIG. 1 is a schematic diagram showing a hydrogen engine and a controller configured to control the hydrogen engine.

FIG. 2 is a flowchart showing a process executed by the controller shown in FIG. 1.

FIG. 3 is a flowchart showing a process executed by the controller shown in FIG. 1.

FIG. 4 is a flowchart showing an intake system anomaly determination process shown in FIG. 3.

FIG. 5 is a graph relating to the λ limit referred to in the processing shown in FIG. 4.

FIG. 6 is a time chart for explaining the operation.

FIG. 7 is a flowchart showing an intake system anomaly determination process according to a modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

Hereinafter, a hydrogen engine controller according to an embodiment will be described with reference to the drawings.

### Configuration of Hydrogen Engine 10

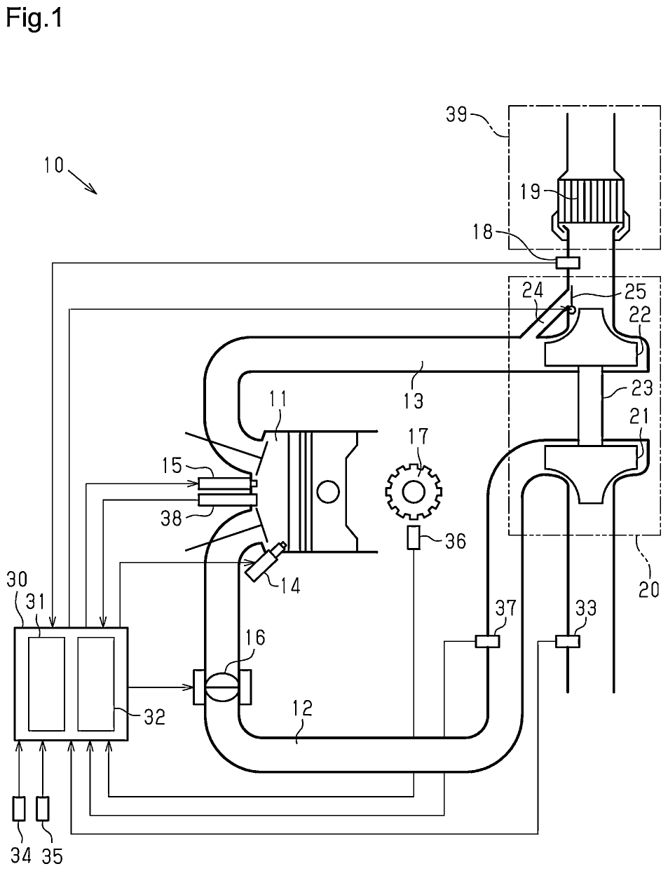

First, the configuration of the hydrogen engine 10 to be controlled by the controller 30 of the hydrogen engine 10 will be described with reference to FIG. 1. The hydrogen engine 10 has cylinders 11. FIG. 1 shows only one of the cylinders 11. The air-fuel mixture is combusted in each of the cylinders 11. In addition, the hydrogen engine 10 includes an intake passage 12 which is an introduction path of intake air to the cylinder 11, and an exhaust passage 13 which is a discharge path of exhaust gas from the cylinder 11. Further, the hydrogen engine 10 includes a direct injector 14 that injects fuel into the cylinder 11 to form an air-fuel mixture. The direct injector 14 is configured such that the fuel passage is opened when the valve body is lifted inward. That is, the direct injector 14 is of the inward-opening valve type. Further, the hydrogen engine 10 includes an ignition device 15 that ignites the air-fuel mixture in the cylinder 11 by spark discharge. A throttle valve 16 is provided in a portion of the intake passage 12 downstream of the compressor wheel 21. The amount of intake air introduced into the cylinder 11 can be adjusted by changing the opening degree of the throttle valve 16. The hydrogen engine 10 generates a driving force of the vehicle by rotating the crankshaft 17 by combustion of an air-fuel mixture in the cylinder 11.

The hydrogen engine 10 includes a forced induction device 20. In the present embodiment, the forced induction device 20 is a so-called turbocharger. The forced induction device 20 includes a compressor wheel 21 provided in the intake passage 12 and a turbine wheel 22 provided in the exhaust passage 13. The compressor wheel 21 is an impeller that compresses intake air in accordance with rotation. The turbine wheel 22 is an impeller that rotates by receiving the flow of the exhaust gas. The compressor wheel 21 and the turbine wheel 22 are connected to each other via a turbine shaft 23. Therefore, the compressor wheel 21 rotates in conjunction with the rotation of the turbine wheel 22.

The exhaust passage 13 is provided with a bypass passage 24 that is a passage for allowing exhaust gas to flow downstream while bypassing the turbine wheel 22. The bypass passage 24 is branched from the exhaust passage 13 at a position upstream of the turbine wheel 22 in the exhaust passage 13. The bypass passage 24 merges with the exhaust passage 13 at a position downstream of the turbine wheel 22 in the exhaust passage 13. A catalyst device 39 having a catalyst carrier 19 on which an exhaust gas purifying catalyst is carried is provided at a portion on the downstream side of the merging position of the bypass passage 24 and the exhaust passage 13.

The exhaust passage 13 is provided with a wastegate valve 25 that opens and closes an outlet of the bypass passage 24. The wastegate valve 25 is disposed in the exhaust passage 13 at a position downstream of the junction between the bypass passage 24 and the exhaust passage 13 and upstream of the catalyst device 39. The exhaust passage 13 is provided with an exhaust gas temperature sensor 18 for detecting an exhaust gas temperature. The exhaust gas temperature sensor 18 is disposed downstream of the wastegate valve 25 and upstream of the catalyst device 39 in the exhaust passage 13.

The wastegate valve 25 is provided at an outlet of the bypass passage 24. The bypass passage 24 is opened and closed by a wastegate valve 25. When the wastegate valve 25 is open, a portion on the exhaust upstream side of the turbine wheel 22 and a portion on the exhaust downstream side of the turbine wheel 22 communicate with each other. When the wastegate valve 25 is opened, the exhaust gas flows through the bypass passage 24. The exhaust gas flowing through the bypass passage 24 does not contribute to the rotation of the turbine wheel 22. As the opening degree of the wastegate valve 25 increases, the flow rate of the exhaust gas bypassing the turbine wheel 22 increases. As a result, boost pressure generated by the driving of the forced induction device 20 is reduced.

### Configuration of Controller 30

The hydrogen engine 10 is controlled by a controller 30. The controller 30 includes a control unit 31 and a read only memory (ROM) 32. The control unit 31 includes a central processing unit (CPU) and a random access memory (RAM). The ROM32 stores a program for controlling the hydrogen engine 10. The control unit 31 controls the hydrogen engine 10 by reading and executing a program from a ROM32.

Detection results of various sensors for detecting the operation state of the hydrogen engine 10 are input to the controller 30. The various sensors include an airflow meter 33, a vehicle speed sensor 34, an accelerator position sensor 35, a crank angle sensor 36, a boost pressure sensor 37, an in-cylinder pressure sensor 38, and the exhaust gas temperature sensor 18.

The airflow meter 33 is a sensor that detects an intake air amount that is a flow rate of intake air flowing through the intake passage 12. In the present embodiment, the airflow meter 33 is positioned upstream of the compressor wheel 21 in the intake passage 12. The vehicle speed sensor 34 is a sensor that detects the speed of the vehicle. The accelerator position sensor 35 is a sensor that detects a depression amount of an accelerator pedal. The crank angle sensor 36 is a sensor that detects a crank angle that is a rotation angle of the crankshaft 17. The boost pressure sensor 37 is a sensor that detects a boost pressure, which is a pressure of intake air in a portion of the intake passage 12 downstream of the compressor wheel 21 and upstream of the throttle valve 16. The in-cylinder pressure sensor 38 is a sensor that detects an in-cylinder pressure that is a pressure in the cylinder 11. The control unit 31 of the controller 30 controls the opening degree of the wastegate valve 25 based on the detection results of these sensors. Based on the detection results of these sensors, the control unit 31 controls the fuel injection amount and fuel injection timing of the direct injector 14, the ignition timing of the ignition device 15, the throttle opening degree, and the like.

### Processing Executed by Controller 30

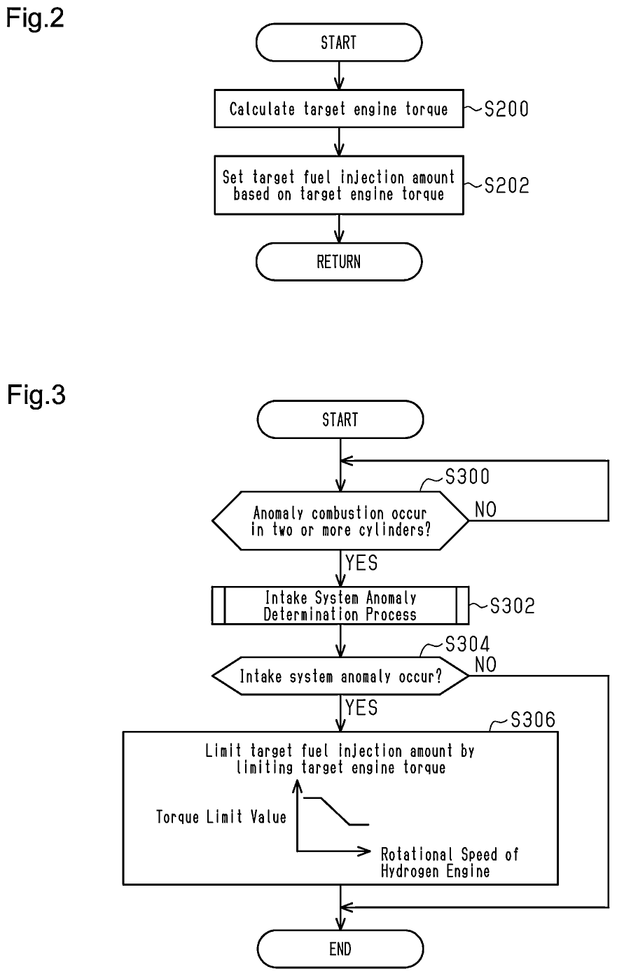

A process executed by the controller 30 will be described with reference to FIGS. 2 to 5.

The process shown in FIG. 2 is started when the hydrogen engine 10 is started. During operation of the hydrogen engine 10, the controller 30 repeatedly performs the processing shown in FIG. 2. The controller 30 calculates the target engine torque in step S200. For example, the controller 30 calculates the target engine torque based on the accelerator depression amount or the like acquired from the accelerator position sensor 35. Next, the controller 30 proceeds to step S202. In step S202, the controller 30 sets the target fuel injection amount based on the target engine torque. In the present embodiment, the controller 30 calculates the target fuel injection amount by multiplying the target engine torque by a certain coefficient. In this way, the controller 30 repeatedly sets the target fuel injection amount based on the target engine torque.

The process shown in FIG. 3 is started when the hydrogen engine 10 is started. In step S300, the controller 30 determines whether anomaly combustion occurs in two or more cylinders 11. The anomaly combustion is an anomaly in which combustion occurs at a timing different from the ignition timing. For example, the anomaly combustion is pre-ignition and/or knocking. The controller 30 can determine whether anomaly combustion has occurred based on the crank angle acquired from the crank angle sensor 36 and the in-cylinder pressure acquired from the in-cylinder pressure sensor 38. For example, the controller 30 determines that anomaly combustion has occurred when the in-cylinder pressure is larger than a threshold value within a predetermined crank angle range excluding the top dead center. Alternatively, the controller 30 may determine whether anomaly combustion has occurred, based on an ion current detected by collecting positive ions generated during combustion. When a negative determination is made in step S300 (S300: NO), the controller 30 repeats the process of step S300. If a positive determination is made in step S300 (S300: YES), the controller 30 proceeds to step S302. According to step S300, the controller 30 repeatedly determines whether anomaly combustion, which is an anomaly in which combustion occurs at a timing different from the ignition timing, occurs in two or more cylinders 11. The controller 30 executes the intake system anomaly determination process of step S302 on condition that it is determined that an anomaly combustion has occurred in two or more of the cylinders 11.

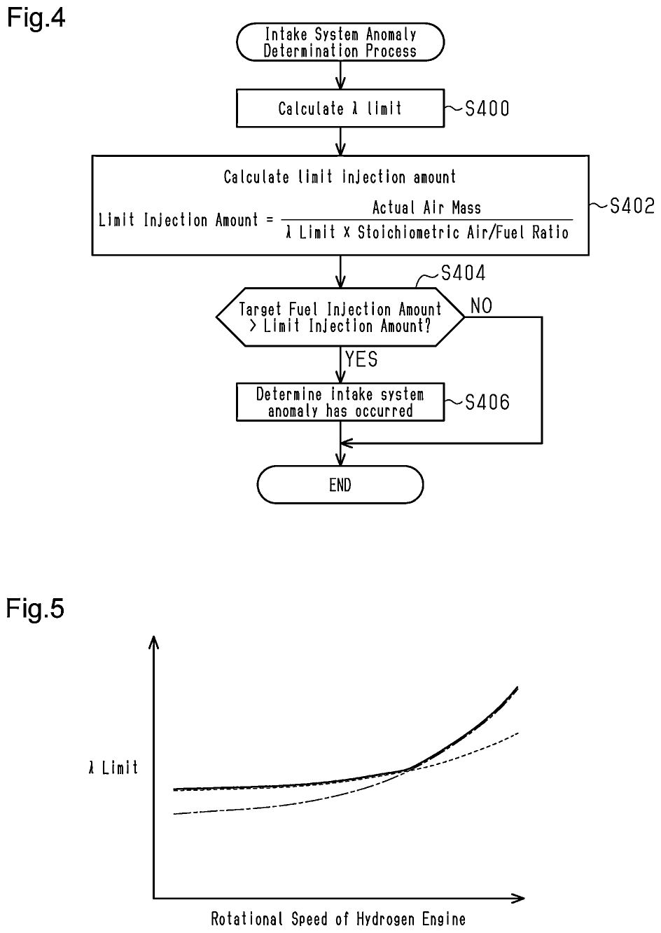

The intake system anomaly determination process executed by the controller 30 in step S302 will be described with reference to FIGS. 4 and 5. The intake system anomaly determination process is processing for determining whether an intake system anomaly has occurred. The intake system anomaly is an anomaly in which the amount of air supplied to the cylinders 11 becomes small. Two types of anomalies in which the amount of air supplied to the cylinders 11 becomes small will be described next. The first type of anomaly is an anomaly in which the wastegate valve 25 cannot be closed. For example, when all of the exhaust gas needs to contribute to the rotation of the turbine wheel 22, the wastegate valve 25 needs to be closed. When the first type of anomaly occurs, the turbine wheel 22 cannot be sufficiently rotated by the exhaust gas. As a result, the amount of air supplied to the cylinder 11 decreases. The second type of anomaly is an anomaly in which the exhaust gas leaks from a location on the upstream side of the turbine wheel 22 in the exhaust passage 13. In such a case, the rotation of the turbine wheel 22 is reduced by the amount of leakage of the exhaust gas. As a result, the amount of air supplied to the cylinder 11 decreases.

In step S400, the controller 30 calculates the λ limit. The λ limit is a limit value of λ which is an excess air ratio. First, the excess air ratio will be described. The excess air ratio is a value obtained by dividing the actual air mass by the minimum air mass. The actual air mass is the mass of the air actually supplied to the cylinder 11. The minimum air mass is the mass of air required for combustion at the stoichiometric air-fuel ratio in the cylinder 11. The excess air ratio is an index representing an excess degree of air in the air-fuel mixture. The excess air ratio is equal to the actual air-fuel ratio divided by the stoichiometric air-fuel ratio. When λ=1, the air-fuel ratio is stoichiometric. When λ>1, the air-fuel ratio is leaner than the stoichiometric air-fuel ratio. When λ<1, the air-fuel ratio is richer than the stoichiometric air-fuel ratio.

During operation of the hydrogen engine 10, air sufficient for lean combustion is normally supplied to the cylinder 11. When the amount of air supplied to the cylinder 11 excessively decreases, the possibility of occurrence of anomaly combustion increases. As shown in FIG. 5, the λ limit is calculated in accordance with the rotational speed of the hydrogen engine 10. For example, the λ limit is calculated using a map that associates the rotational speed of the hydrogen engine 10 with the λ limit. The map is obtained in advance through an experiment. In this experiment, it is shown that the possibility of occurrence of anomaly combustion increases when the excess air ratio falls below the λ limit.

As shown by the solid line in FIG. 5, the λ limit increases as the rotational speed of the hydrogen engine 10 increases. The λ limit is determined by a requirement from the viewpoint of suppressing knocking indicated by a broken line and a requirement from the viewpoint of suppressing pre-ignition indicated by an alternate long and short dash line. As described above, when the excess air ratio falls below the λ limit, the possibility of occurrence of anomaly combustion increases. When the λ limit is expressed using the Max function, λ limit=Max {the limit value of the excess air ratio determined from the viewpoint of suppressing knocking, the limit value of the excess air ratio determined from the viewpoint of suppressing pre-ignition}. The Max function used here is a function that returns the maximum value among a plurality of arguments. In the low engine speed region, the limit value of the excess air ratio determined from the viewpoint of suppressing knocking is larger than the limit value of the excess air ratio determined from the viewpoint of suppressing pre-ignition. In the high engine speed region, the limit value of the excess air ratio determined from the viewpoint of suppressing knocking is smaller than the limit value of the excess air ratio determined from the viewpoint of suppressing pre-ignition. The requirement from the viewpoint of suppressing knocking indicated by the broken line will be described below. When the air-fuel ratio becomes rich, combustion starts earlier and the combustion temperature becomes higher. Therefore, a demand for setting the air-fuel ratio to be lean is higher in the high engine speed range than in the low engine speed range. That is, the limit value of the excess air ratio is higher in the high engine speed range than in the low engine speed range. The requirement from the viewpoint of suppressing the pre-ignition indicated by the one dot chain line will be described below. Pre-ignition occurs due to, for example, residual flame or residual gas. The remaining flame is more difficult to extinguish in a high rotation region than in a low rotation region. In addition, since the residual combustion temperature is higher in the high rotation region than in the low rotation region, the temperature of the residual gas is also high. Therefore, there is a higher demand for setting the air-fuel ratio to be lean in the high engine speed range than in the low engine speed range.

Returning to FIG. 4, the controller 30 calculates the λ limit in step S400, and then proceeds to step S402. In step S402, the controller 30 calculates the limit injection amount. The limit injection amount is calculated by dividing the actual air mass by the value obtained by multiplying the lambda limit by the stoichiometric air/fuel ratio. The actual air mass can be calculated from the intake air amount detected by the airflow meter 33. Since the limit injection amount is proportional to the actual air mass, the limit injection amount decreases as the intake air amount detected by the airflow meter 33 decreases. Next, the controller 30 proceeds to step S404.

As described above, when the excess air ratio falls below the λ limit, the possibility of occurrence of anomaly combustion increases. The limit injection amount is inversely proportional to the λ limit. Therefore, when the target fuel injection amount is larger than the limit injection amount, the possibility of occurrence of anomaly combustion increases. The limit injection amount decreases as the rotational speed of the hydrogen engine 10 increases. In step S404, the controller 30 determines whether the target fuel injection amount is larger than the limit injection amount. If a positive determination is made in step S404 (S404: YES), the controller 30 proceeds to step S406. In step S406, the controller 30 determines that the above-described intake system anomaly has occurred. As described above, according to step S404 and step S406, the controller 30 determines that an intake system anomaly has occurred when the target fuel injection amount is larger than the limit injection amount. The controller 30 ends the flow of FIG. 4 after ending the process of step S406 or after making a negative determination in step S404 (S404: NO).

Returning to FIG. 3, the controller 30 proceeds to step S304 after the process of step S302. If it is determined in the intake system anomaly determination process that an intake system anomaly has occurred (S304: YES), the controller 30 proceeds to step S306. As described with reference to FIG. 2, the controller 30 sets the target fuel injection amount based on the target engine torque. In step S306, the controller 30 limits the target fuel injection amount by limiting the target engine torque to the torque limit value or less. The torque limit value decreases as the rotational speed of the hydrogen engine 10 increases. For example, the torque limit value is determined in advance through experiments such that the in-cylinder pressure is equal to or less than a predetermined value when the target engine torque is equal to or less than the torque limit value. The predetermined value may be determined in advance from the viewpoint of avoiding damage to the direct injector 14. As described above, according to steps S302 to S306, when it is determined that an intake system anomaly has occurred, the controller 30 limits the target fuel injection amount by limiting the target engine torque to the torque limit value or less. The controller 30 ends the flow of FIG. 3 after ending the process of step S306 or after making a negative determination in step S304 (S304: NO).

### Operation of Present Embodiment

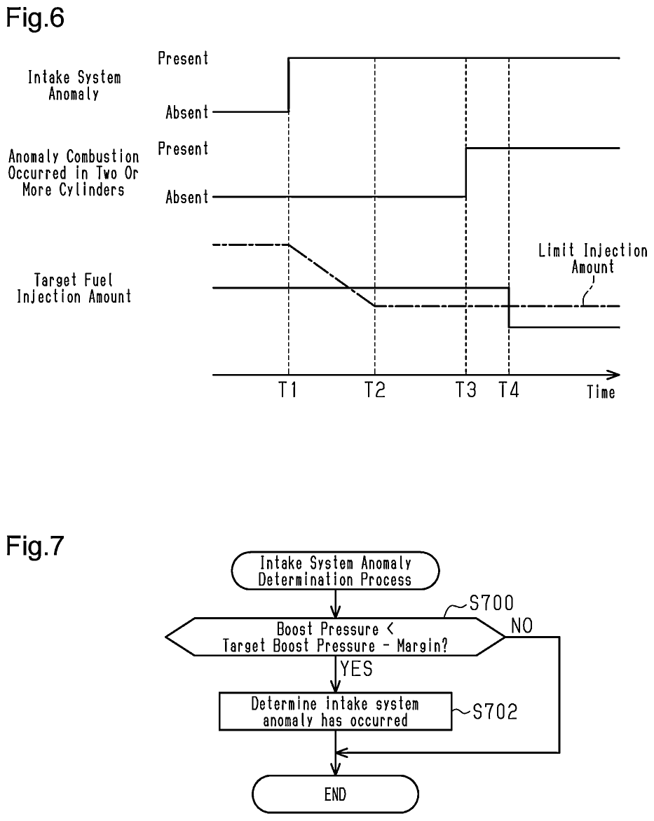

The operation of the present embodiment will be described with reference to FIG. 6. A description will be given of a case where the above-described second type of anomaly suddenly occurs at time T1 while the engine 10 is operating in a stationary state. In the steady state, the target fuel injection amount is stabilized at a constant value. Further, the wastegate valve 25 is closed. At time T1, anomaly combustion has not occurred in two or more cylinders 11.

From the time T1 to the time T2, the intake air amount decreases as the rotation of the turbine wheel 22 decreases. Therefore, the limit injection amount decreases from the time T1 to the time T2. At the time T2, the target fuel injection amount is larger than the limit injection amount. In FIG. 6, the limit injection amount is indicated by a one dot chain line. The controller 30 calculates the limit injection amount when the anomaly combustion occurs in two or more cylinders 11 (S300: YES, S402). In FIG. 6, the limit injection amount before anomaly combustion occurs in the two or more cylinders 11 is also indicated by the alternate long and short dash line.

At the time T3, anomaly combustion is occurring in two or more cylinders 11. Further, the target fuel injection amount is larger than the limit injection amount. Therefore, an affirmative determination is made in step S300 and step S404. As a result, the target fuel injection amount is limited after the time T4 (S306).

### Advantages of Present Embodiment

(1) The hydrogen engine 10 includes the forced induction device 20 and the cylinders 11. The controller 30 of the hydrogen engine 10 controls the hydrogen engine 10. The controller 30 repeatedly sets the target fuel injection amount based on the target engine torque (S202). The controller 30 repeatedly determines whether anomaly combustion, which is an anomaly in which combustion occurs at a timing different from the ignition timing, is occurring (S300). The controller 30 executes the intake system anomaly determination process on condition that it is determined that anomaly combustion has occurred in two or more of the cylinders 11 (S300: YES, S302). The intake system anomaly determination process determines whether an intake system anomaly, which is an anomaly in which the amount of air supplied to the cylinders 11 is decreased, has occurred. When it is determined that the intake system anomaly has occurred, the controller 30 limits the target fuel injection amount (S304: YES, S306).

When anomaly combustion is occurring in two or more cylinders 11, there is a high possibility of occurrence of an intake system anomaly, which is an anomaly of the intake system in which the amount of air supplied to the cylinders 11 is decreased. Hence, when the anomaly combustion is occurring in two or more cylinders 11, the controller 30 determines whether the intake system anomaly has occurred.

When determining that the intake system anomaly has occurred, the controller 30 limits the target fuel injection amount. This inhibits enrichment of the air-fuel ratio. Thus, when the intake system anomaly occurs, anomaly combustion is limited.

The direct injector 14 is of the inward-opening valve type. With this structure, if the in-cylinder pressure becomes excessively high due to pre-ignition, the combustion gas may flow into the direct injector 14. The combustion gas flowing into the direct injector 14 may damage the direct injector 14. According to the above embodiment, since the anomaly combustion is limited so that the direct injector 14 is less likely to be damaged.

(2) The controller 30 determines whether the target fuel injection amount is greater than the limit injection amount on condition that it is determined that anomaly combustion has occurred in two or more of the cylinders 11 (S300: YES, S404). When the target fuel injection amount is larger than the limit injection amount, the controller 30 determines that the intake system anomaly has occurred (S404: YES, S406). The limit injection amount decreases as the intake air amount detected by the airflow meter 33 decreases (S402).

The controller 30 sets a target fuel injection amount based on the target engine torque. During the operation of the hydrogen engine 10, air sufficient for lean combustion is normally supplied to the cylinders 11. Accordingly, the target fuel injection amount is normally less than or equal to the limit injection amount. In such a case, the possibility of occurrence of anomaly combustion is sufficiently low.

When the target fuel injection amount is greater than the limit injection amount, the controller 30 determines that an intake system anomaly has occurred. According to the above configuration, whether the intake system anomaly has occurred is determined based on comparison of the target fuel injection amount with the limit injection amount.

(3) The limit injection amount decreases as the rotational speed of the engine 10 increases (S402, FIG. 5).

As the rotational speed of the hydrogen engine 10 increases, the temperature of the hydrogen engine 10 increases. Thus, as the rotational speed of the hydrogen engine 10 increases, anomaly combustion is more likely to occur. Therefore, as the rotational speed of the hydrogen engine 10 increases, the need for a lean air-fuel ratio is increased so that occurrence of anomaly combustion is inhibited.

According to the above configuration, as the rotational speed of the hydrogen engine 10 increases and thus the anomaly combustion is more likely to occur, the limit injection amount is decreased. Therefore, changes in the likelihood of occurrence of anomaly combustion in accordance with changes in the rotational speed of the hydrogen engine 10 are reflected in the determination of whether the intake system anomaly has occurred.

(4) When determining that the intake system anomaly has occurred, the controller 30 limits the target engine torque to be less than or equal to the torque limit value, thereby limiting the target fuel injection amount (S306). The torque limit value decreases as the rotational speed of the hydrogen engine 10 increases.

As the rotational speed of the hydrogen engine 10 increases, the need for a lean air-fuel ratio is increased to limit occurrence of anomaly combustion. According to the above configuration, the torque limit value decreases as the rotational speed of the hydrogen engine 10 increases. Therefore, the rotational speed of the hydrogen engine 10 is reflected in the degree of limitation on the target fuel injection amount for limiting occurrence of anomaly combustion.

### MODIFIED EXAMPLES

The above embodiment may be modified as described below. The present embodiment and the following modifications can be combined as long as they remain technically consistent with each other.

In the above embodiment, the controller 30 executes the intake system anomaly determination process on condition that it is determined that anomaly combustion has occurred in two or more of the cylinders 11. For example, the controller 30 may execute the intake system anomaly determination process on condition that it is determined that anomaly combustion has occurred in three or more of the cylinders 11. The number of cylinders 11 in which anomaly combustion has occurred, which is counted to determine whether to execute the intake system anomaly determination process, may be changed in accordance with the number of the cylinders 11 included in the hydrogen engine 10.

In the above-described embodiment, the controller 30 limits the target fuel injection amount by limiting the target engine torque to the torque limit value or less. Alternatively, the controller 30 may directly limit the target fuel injection amount. For example, the controller 30 may limit the target fuel injection amount such that the excess air ratio is equal to or higher than a desired excess air ratio.

In the above embodiment, the intake system anomaly determination process has been described with reference to FIG. 4. However, the intake system anomaly determination process shown in FIG. 4 is merely an example.

Next, the intake system anomaly determination process according to a modified example will be described with reference to FIG. 7. In step S700, the controller 30 determines whether the boost pressure is smaller than a value obtained by subtracting the margin from the target boost pressure. The boost pressure can be acquired from the boost pressure sensor 37. The target boost pressure is calculated based on the accelerator depression amount or the like acquired from the accelerator position sensor 35. The margin is appropriately determined in advance. If a positive determination is made in step S700 (S700: YES), the controller 30 proceeds to step S702. The controller 30 determines that an intake system anomaly has occurred in step S702. After the process of step S702 is finished, or when a negative determination is made in step S700 (S700: NO), the controller 30 finishes the flow of FIG. 7. According to the configuration of FIG. 7, it is possible to determine the occurrence of an intake system anomaly related to the above-mentioned first type anomaly and second type anomaly. Further, it is possible to determine the occurrence of an intake system anomaly related to an anomaly in which air leaks from a location of the intake passage 12 between the compressor wheel 21 and the boost pressure sensor 37.

The process of step S700 in FIG. 7 may be changed to a process of determining whether the actual engine load factor is smaller than a value obtained by subtracting the margin from the target engine load factor. Here, the engine load factor is a value indicating the ratio of the current intake air amount to the maximum value of the intake air amount corresponding to the rotational speed of the hydrogen engine 10. Therefore, when the intake air amount is equal to the maximum value, the engine load factor is “100%.”

The process of step S700 in FIG. 7 may be changed to a process of determining whether the actual torque is smaller than a value obtained by subtracting the margin from the target torque.

The process of step S700 in FIG. 7 can be changed to a process of determining whether a logical product condition including two or more of the following conditions (A), (B), and (C) is satisfied. The condition (A) is a condition that the boost pressure is smaller than a value obtained by subtracting the margin from the target boost pressure. The condition (B) is a condition that the actual engine load factor is smaller than a value obtained by subtracting the margin from the target engine load factor. The condition (C) is a condition that the actual torque is smaller than a value obtained by subtracting the margin from the target torque.

The process of step S700 in FIG. 7 can be changed to a process of determining whether a logical sum condition including two or more of the above conditions (A), (B), and (C) is satisfied.

In the above embodiment, the airflow meter 33 is positioned upstream of the compressor wheel 21 in the intake passage 12. Instead of this, the airflow meter 33 may be positioned downstream of the compressor wheel 21 in the intake passage 12. In such a case, it is possible to determine the occurrence of an intake system anomaly related to an anomaly in which air leaks from a location of the intake passage 12 between the compressor wheel 21 and the boost pressure sensor 37.

In the above embodiment, the forced induction device 20 is a turbocharger. Alternatively, the forced induction device 20 may be a supercharger. The supercharger supplies compressed air to the cylinder 11 by driving the compressor with power extracted from the crankshaft 17 of the hydrogen engine 10 via a belt. The compressor may be driven by an electric motor. The airflow meter 33 may be located downstream of the compressor in the intake passage 12. In this case, it is possible to determine the occurrence of an intake system anomaly related to an anomaly in which air leaks from a location of the intake passage 12 between the compressor and the airflow meter 33.

In the above embodiment, the controller 30 includes the control unit 31 and the ROM32. The control unit 31 includes a CPU and a RAM. The controller 30 executes software processing. However, such a configuration is merely an example. For example, the controller 30 may include a dedicated hardware circuit (for example, an ASIC or the like) that processes at least a part of the software processing executed in the above-described embodiment. That is, the controller 30 may be modified as long as it has any one of the following configurations (a) to (c): (a) The controller 30 includes a processing device that executes all processes in accordance with a program and a program storage device such as a ROM that stores the program. That is, the controller 30 includes a software execution device. (b) The controller 30 includes a processing device that executes a part of processing in accordance with a program, and a program storage device. Further, the controller 30 includes a dedicated hardware circuit that executes the remaining processing. (c) The controller 30 includes a dedicated hardware circuit that executes all processes. There may be more than one software execution device and/or more than one dedicated hardware circuit. That is, the above-described process may be executed by processing circuitry including at least one of a software execution device and a dedicated hardware circuit. The processing circuitry may include a plurality of software execution devices and a plurality of dedicated hardware circuits. The program storage device, or computer readable medium, includes any type of storage device that is a medium accessible by a versatile computer or a dedicated computer.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A hydrogen engine controller configured to control a hydrogen engine including a forced induction device and cylinders, the hydrogen engine controller, comprising:
processing circuitry, wherein
the processing circuitry is configured to repeatedly set a target fuel injection amount based on a target engine torque,
the processing circuitry is configured to repeatedly determine whether an anomaly combustion is occurring, the anomaly combustion being an anomaly in which a combustion occurs at a point in time differing from an ignition timing,
when determining that the anomaly combustion has occurred in two or more of the cylinders, the processing circuitry is configured to determine whether an intake system anomaly has occurred, the intake system anomaly being an anomaly in which an amount of air supplied to the cylinders is decreased, and
when determining that the intake system anomaly has occurred, the processing circuitry is configured to limit the target fuel injection amount.

2. The hydrogen engine controller according to claim 1, wherein
when determining that the anomaly combustion has occurred in two or more of the cylinders, the processing circuitry is configured to determine whether the target fuel injection amount is greater than a limit injection amount,
when determining that the target fuel injection amount is greater than the limit injection amount, the processing circuitry is configured to determine that the intake system anomaly has occurred, and
the limit injection amount decreases as an intake air amount detected by an airflow meter decreases.

3. The hydrogen engine controller according to claim 2, wherein the limit injection amount decreases as a rotational speed of the hydrogen engine increases.

4. The hydrogen engine controller according to claim 1, wherein
when determining that the intake system anomaly has occurred, the processing circuitry is configured to limit the target engine torque to be less than or equal to a torque limit value, thereby limiting the target fuel injection amount, and
the torque limit value decreases as a rotational speed of the hydrogen engine increases.
